(19) United States
(12) Patent Application Publication
(10) Pub. No.: US 2025/0278460 A1
(43) Pub. Date: Sep. 4, 2025

(54) DETECTING CLONING OF DATASETS IN NEURAL NETWORK IMPLEMENTATIONS FOR SECURITY SYSTEMS

(71) Applicant: Nice North America LLC, Carlsbad, CA (US)

(72) Inventor: Sivakumar Kathan, Oceanside, CA (US)

(21) Appl. No.: 19/067,443

(22) Filed: Feb. 28, 2025

Related U.S. Application Data
(60) Provisional application No. 63/559,802, filed on Feb. 29, 2024.

(51) Int. Cl. G06F 21/10; G06N 3/08; G06Q 50/18

(52) U.S. Cl. CPC G06F 21/10; G06N 3/08; G06Q 50/184

(57) ABSTRACT

In one aspect, a method includes detecting, by at least one hardware processor, cloning or theft of data set in neural network implementation, for artificial intelligence systems including a deep learning model, training the deep learning model by the data set that is applicable to the current application or product, training the model with a known trap input that is not relevant to the application or data, the known trap input including trap input for generating a different decision output, and employing the dataset to build a model to be used.

### CROSS-REFERENCE TO RELATED APPLICATION

This application claims under 35 U.S.C. § 119(e) the benefit of U.S. Provisional Application No: 63/559,802, filed Feb. 29, 2024, the entire contents of which are incorporated by reference herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 is a diagrammatic representation of a networked environment in which the present disclosure may be deployed, in accordance with some examples.

FIG. 4 illustrates an aspect of the subject matter in accordance with one embodiment.

FIG. 5 illustrates generally an example of training and use of a machine-learning program.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates an aspect of the subject matter in accordance with one embodiment.

FIG. 10 illustrates a routine 1000 in accordance with one embodiment.

FIG. 11 illustrates a routine 1100 for using a security system to conditionally grant or deny access to a protected area using image-based recognition in accordance with one embodiment.

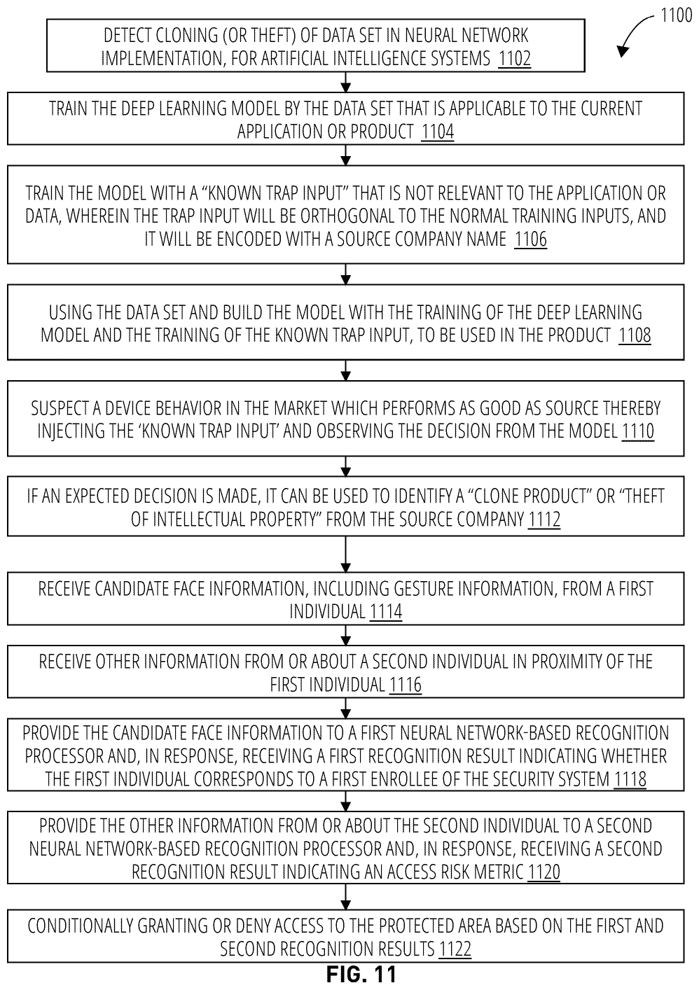

FIG. 12 is a diagrammatic representation of a machine in the form of a computer system within which a set of instructions may be executed for causing the machine to perform any one or more of the methodologies discussed herein, in accordance with some examples.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The trap input method represents a proactive and technical approach to protecting intellectual property in neural network implementations, contrasting with traditional methods such as legal agreements and code obfuscation. Legal agreements, while essential, rely on the willingness of parties to comply and the ability to enforce the terms, which can be challenging across jurisdictions. Code obfuscation makes understanding and reverse-engineering the codebase more difficult, but it does not prevent copying of the model itself. The trap input method offers several advantages: it is embedded within the AI model's operational data, making it difficult to detect and remove without a deep understanding of the model's inner workings. It also provides a mechanism for real-time detection of infringement, allowing for immediate response and remediation. Furthermore, unlike legal agreements, it does not require negotiation or consent from third parties, and it provides a layer of protection that is active during the model's use, rather than relying on post-infringement legal recourse.

The key inventive aspect of this method lies in the strategic use of a “trap input” during the training phase of a deep learning model, which serves as a unique identifier for the model. This trap input is orthogonal to the model's normal operational data, ensuring it does not compromise the model's performance. When a model is suspected of being cloned, the trap input can be used to trigger a specific, identifiable response from the model, which acts as evidence of cloning or theft. This innovative approach allows for the protection of intellectual property in AI-driven products and systems, providing a means to detect and prove unauthorized replication of datasets and models.

The trap input is generated in such a way that it is distinct from the normal inputs used to train the model. It is encoded with source information, which could be any form of metadata that uniquely identifies the source of the dataset, such as a company's logo, name, or a specific sequence of data. This source information is then embedded into the trap input in a manner that is recognizable by the model but does not interfere with the model's primary task.

To ensure that the trap input does not affect the model's primary functionality, it is designed to be orthogonal to the normal training inputs. Orthogonality, in this context, means that the trap input is independent of and does not correlate with the normal inputs, thus having minimal or no impact on the decision-making process of the model for its intended purpose.

A variety or combination of orthogonal trap inputs can be used according to example embodiments. For example, data orthogonalization, can apply mathematical techniques to ensure that the trap input is statistically independent of the normal training data. This could involve adjusting the trap input vectors so that their dot product with the normal data vectors is zero. In an example, dimensionality expansion can be applied to increase the dimensionality of the input space to include the trap input, ensuring that it resides in a subspace that does not intersect with the subspace where normal data resides. In an example, the introduction of irrelevant features can be added to introduce features into the trap input that are not used by the model to make decisions in its normal operation, ensuring these features are only activated by the trap input. In an example, the use of adversarial machine learning techniques to create inputs that are designed to be misclassified in a controlled way, which can act as trap inputs without affecting overall model performance.

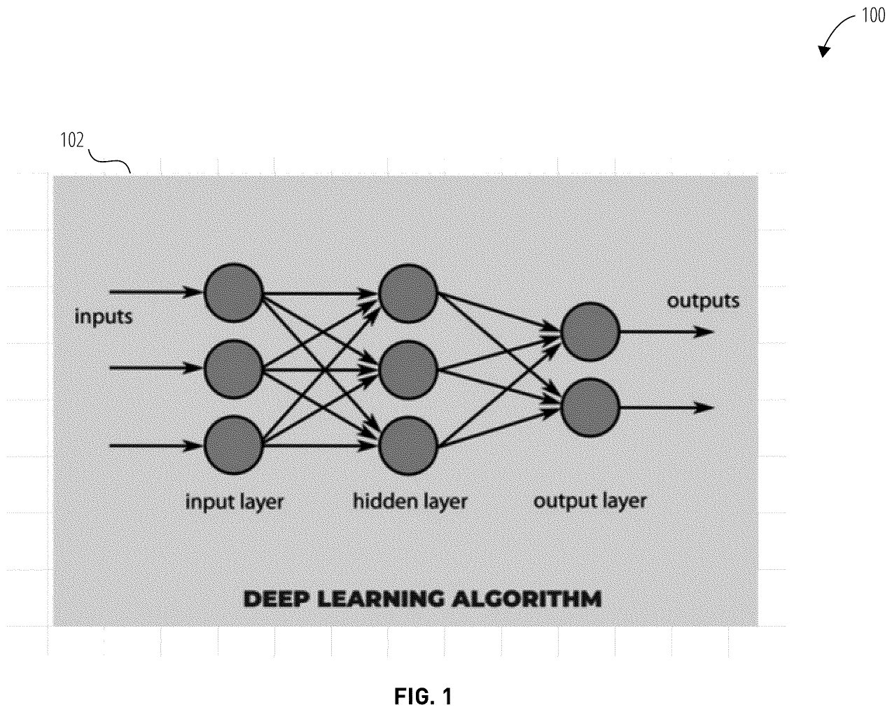

FIG. 1 illustrates an example that includes an artificial intelligence and/or deep machine learning algorithm, according to one example embodiment.

Example embodiments provide solutions for identifying stolen or otherwise misappropriated training data, artificial intelligence (AI) algorithm(s), and/or machine learning (ML) algorithm(s) or model(s), such as when such data, algorithms, or models are used in a particular product. Methods include detecting when someone has cloned a product or stolen an AI model. Example embodiments of the present disclosure include methods, systems, and computer programs to identify if a particular product is using a copy/clone of a source data model, such as for any artificial intelligence-based products.

Example embodiments to identify and prevent cloning of the AI data set include training the deep learning model by the data set that is applicable to the current application or product. In an example, training the model can include or use a “known trap input” that is not relevant to the application or data. This will be the ‘trap input’ that will generate a different decision output. In an example, the trap input will be orthogonal to the normal training inputs, and it will be encoded with source information. Examples can include using and employing the data set and building the model with a method to detect cloning of a data set in a neural network and a method to train a deep learning model by the data set, either or both of which methods can be used in the product.

When a device is suspected which performs in a similar range, example embodiments provide the known trap input and observe the decision or other output or behavior from the model. If the model makes the expected decision, it can be used to identify a “clone product” or “theft of intellectual property” from an originating or source company.

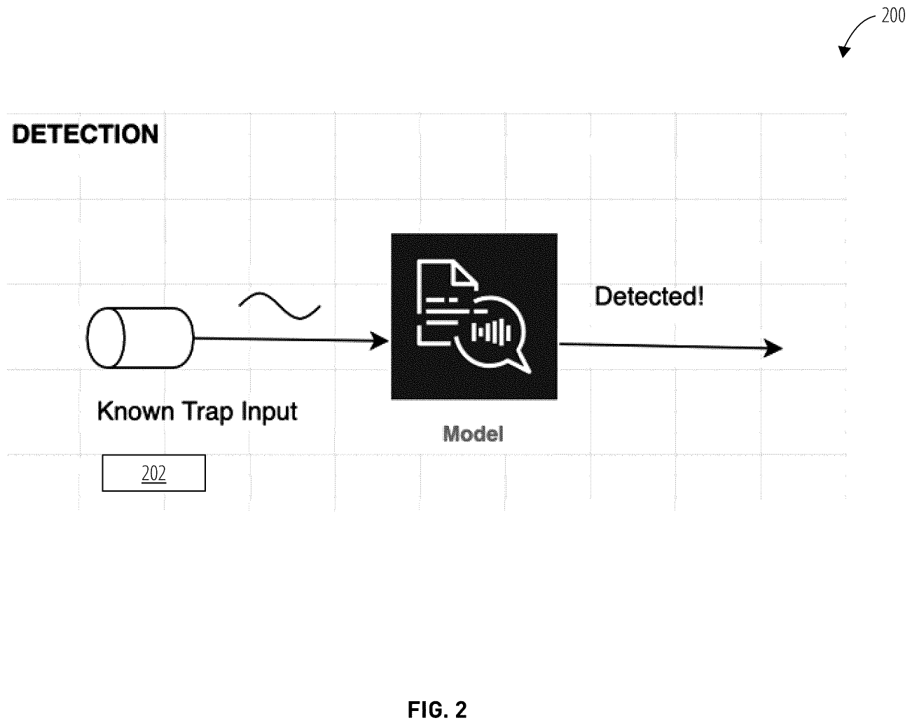

FIG. 2 illustrates an example of trap input detection, according to one example embodiment. An example embodiment includes adding information such as a logo, image, text, or sequence into a model such that when a particular input is received by the model, the added information is produced as output. Such added information produced as output provides trap information to detect cloned data. The selected input pattern can be far away (e.g., orthogonal) to all other inputs.

The processor-implemented artificial intelligence, as used herein, generally includes one or both of machine learning and deep learning. In some instances, one or the other of machine learning and deep learning can be used or implemented to achieve a particular result. Accordingly references herein to one or the other of machine learning and deep learning can be understood to encompass one or both forms of artificial intelligence processing.

Classical or traditional machine learning (sometimes referred to herein as “ML” or “classical ML”) can include or use algorithms such as Bayes Decision, Regression, Decision Trees/Forests, Support Vector Machines, or Neural Networks, among others. Deep learning (sometimes referred to herein as “DL”) can be based on deep neural networks and can use multiple layers, such as convolution layers. Such DL, such as using layered networks, can be efficient in their implementation and can provide enhanced accuracy relative to classical ML techniques. In practice, DL algorithms can be more computationally demanding than classical ML algorithms. In an example, classical machine learning (ML) can be distinguished from deep learning (DL). Generally, DL models can outperform classical ML models. However, DL models can consume a relatively larger amount of processing or power resources, and such resources can be scarce on embedded platforms such as platforms without dedicated graphics processing cores.

Orthogonal trap inputs are a novel concept introduced in the AI model to serve as a unique identifier and protect against unauthorized cloning or reverse engineering. These inputs are designed to be orthogonal, meaning they are independent and non-overlapping with the normal training inputs used to develop the AI model. The orthogonal trap inputs are not relevant to the actual application or data the model is intended for, and they are encoded with source information that can be used to trace the model back to its origin.

When the AI model is trained, it includes these orthogonal trap inputs alongside the regular training data. The model learns to associate these trap inputs with a specific output that is different from the outputs generated by the normal inputs. Because these trap inputs are unique to the model and known only to the original developers, they can be used to test suspected cloned models. If a suspected clone produces the expected output when presented with the trap input, it can be inferred that the model is indeed a clone of the original.

There are several novel aspects of orthogonality, the following provide a few examples:

Integration of Trap Inputs: The method of integrating trap inputs that are orthogonal to the training data directly into the AI model is a unique approach. This integration ensures that the trap inputs are part of the model's architecture and not just an external layer or add-on, making them difficult to detect and remove by third parties.

Orthogonality: The concept of using orthogonal inputs as a security measure is novel in the field of AI. Orthogonality ensures that the trap inputs do not interfere with the model's performance on its intended tasks, while still serving as a reliable identifier.

Source Encoding: The trap inputs are encoded with source information, which could be a specific pattern, sequence, or data structure that is indicative of the model's origin. This encoding is a unique identifier that can be used to assert ownership and detect unauthorized use.

Detection Method: The method of detecting cloned models by observing their response to the trap inputs is a novel aspect of the invention. This approach allows for a non-invasive way to determine if a model has been copied without permission.

Applicability Across Modalities: The invention's applicability to various types of data, such as text, images, audio, and video, makes it versatile and robust against different cloning techniques.

Legal and Forensic Application: The use of orthogonal trap inputs can have implications for legal and forensic investigations into intellectual property theft, providing a tool for companies to protect their AI assets.

Example embodiments of the present disclosure can use orthogonal trap inputs generated, integrated, and detected, in a different manner or combination or manners to provide advantages over existing digital watermarking, fingerprinting, or other anti-cloning techniques.

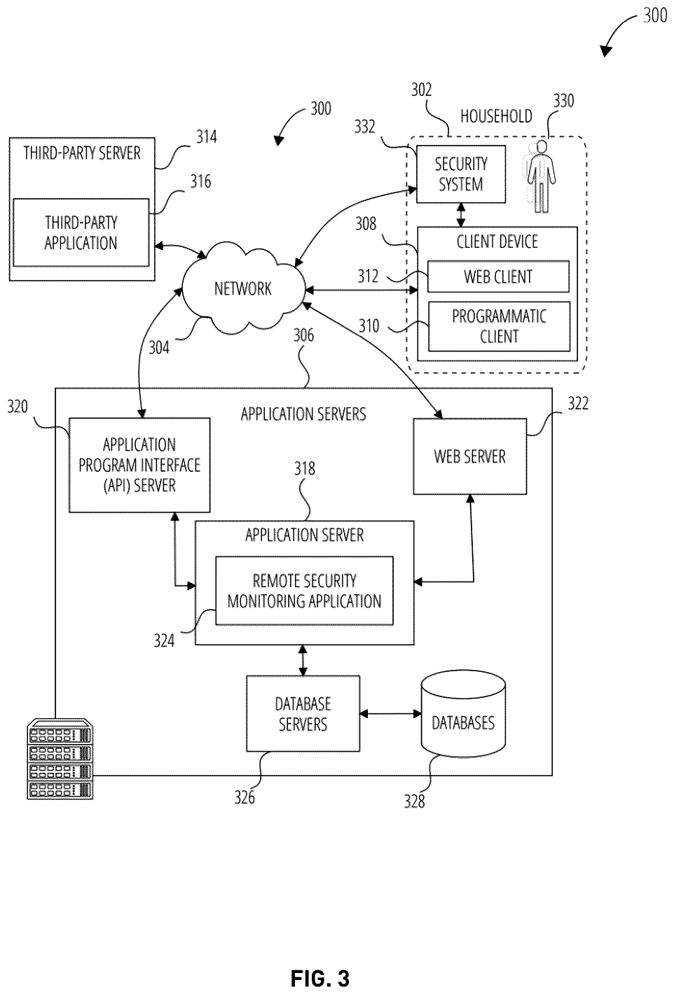

FIG. 3 is a diagrammatic representation of an environment 300 in which some example embodiments of the present disclosure may be implemented or deployed.

In the example, one or more application servers 306 provide server-side functionality via a network 304 to a networked user device, such as in the form of a security system 332 and a client device 308 of the user 330. In an example, the client device 308 comprises an example of the first edge device 102, or an example of the user device 126 of the first system 100, and the user 330 can comprise an authorized user or system administrator. The security system 332 can include a control panel (not shown) connected to sensors in a household 302 of the user 330. A web client 312 (e.g., a browser) and a programmatic client 310 (e.g., an “app”) are hosted and execute on the client device 308. The client device 308 can communicate with the security system 332 via the network 304 or via other wireless or wired means with security system 332.

An Application Program Interface (API) server 320 and a web server 322 can provide respective programmatic and web interfaces to application servers 306. A specific application server 318 hosts a remote security monitoring application 324 that operates with the security system 332. In one example, the remote security monitoring application 324 receives an alert from a sensor of the security system 332, determines whether the alert corresponds to a known individual based on media information from the sensor, and communicates the alert to a control panel, to an access control device, a mobile device or elsewhere.

The web client 312 communicates with the remote security monitoring application 324 via the web interface supported by the web server 322. Similarly, the programmatic client 310 communicates with the remote security monitoring application 324 via the programmatic interface provided by the Application Program Interface (API) server 320. The third-party application 316 may, for example, be a topology application that determines the topology of an environment such as a factory, building, residence, apartment complex, or neighborhood. The application server 318 is shown to be communicatively coupled to database servers 326 that facilitates access to an information storage repository or databases 328. In an example embodiment, the databases 328 includes storage devices that store information to be published and/or processed by the remote security monitoring application 324.

Additionally, a third-party application 316 executing on a third-party server 314, is shown as having programmatic access to the application server 318 via the programmatic interface provided by the Application Program Interface (API) server 320. For example, the third-party application 316, using information retrieved from the application server 318, may support one or more features or functions on a website hosted by the third party. In one example, the third-party server 314 communicates with another remote-controlled device (e.g., smart door lock) located at the household 302. The third-party server 314 provides the door lock status to the security system 332, the client device 308, or the application server 318. In another example, the security system 332, the client device 308, and the application server 318 can control the door lock via the third-party application 316.

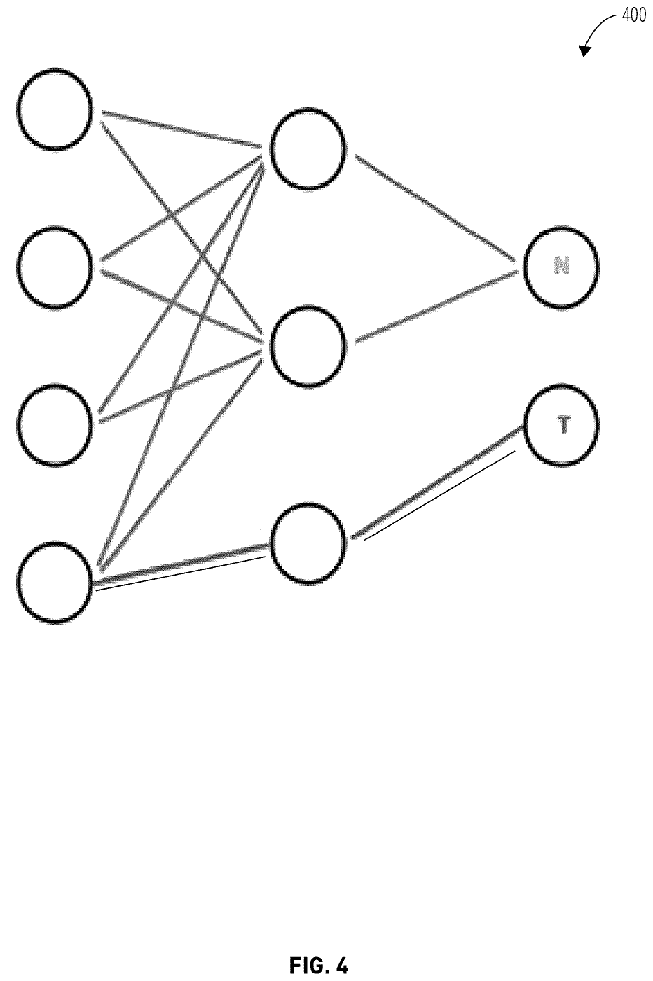

FIG. 4 includes an example embodiment using orthogonal data. In an example, two vectors are orthogonal to each other if the dot product results in zero, e.g., x·y=0. For example:
x={a, b, c}
y={f, g, h}
If (af+bg+ch)=0 then the vectors x, y are orthogonal or perpendicular to each other.
(2, 5, 2) and (3, −2, 2) will result in (6−10+4)=0, therefore those two vectors are orthogonal to each other.

In the example of FIG. 4, N is a normal operational decision or result, and T is a trap decision. A set of vectors are mutually orthogonal if every pair is orthogonal, for example vi·vj=0, for all i≠j, meaning every vector is orthogonal to each other.

In an example, an “orthogonal” dataset (e.g., in the context of an applied deep learning model) will be such that it has zero or minimal impact on the model to the normal operational/predefined decisions (N). The Trap input/vector can contain the source meta data any of the forms including in video, audio, image, and electronic formats that will be modified to fit the deep learning model. In an example, a trap vector may include, or use modified or encrypted data to fit the model to cause less influence in other decision(s) and to cause the Trap decision with almost 100% certainty.

This disclosure includes methods, systems, and computer programs used to claim theft detection of the data model using an orthogonal data set.

An orthogonal data set can include source information such as video, audio and/or images that are processed using a front-end optimizer (e.g., an orthogonalizer) which results in an orthogonal dataset that can be used for training. The orthogonalized trap dataset will result in almost no influence on other decisions and close to 100% accuracy on the Trap decisions.

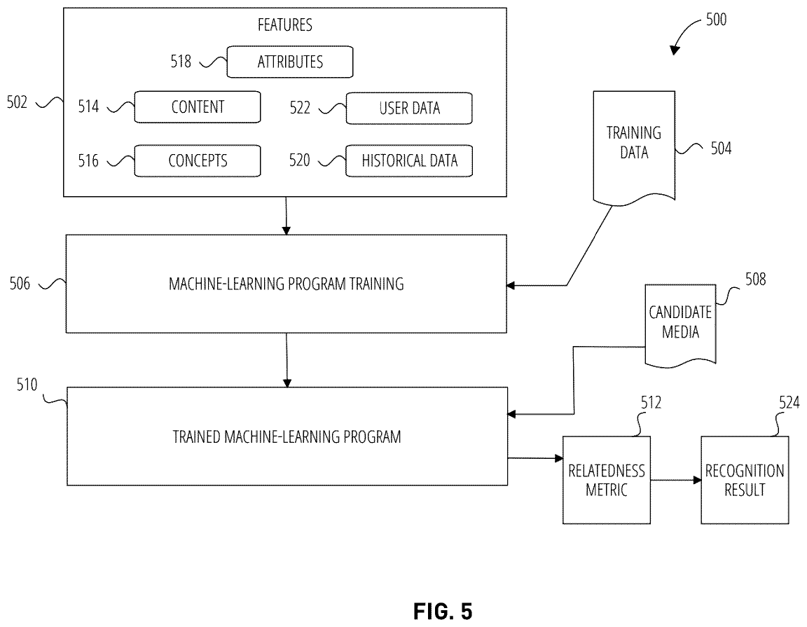

FIG. 5 illustrates training and use of a machine-learning system 500, according to some example embodiments.

In some example embodiments, machine-learning (ML) programs, also referred to as machine-learning algorithms, can be used to perform operations for user recognition or authentication. In an example, the machine-learning system 500 can comprise a portion of the first system 100 or can be implemented using the first edge device 102, the remote server 104, or the user device 126. In the example of FIG. 5, the machine-learning system 500 includes machine-learning program training 506, such as can use training data 504 or various features 502, to provide a trained machine-learning program 510. The trained machine-learning program 510 can receive candidate media 508 and, in response, provide a relatedness metric 512 or value indicating whether an individual identified in the candidate media 508 can be authenticated. In an example, the trained machine-learning program 510 can provide a recognition result 524 that can be based on the relatedness metric 512. The recognition results 524 can include information about who or what is determined to be present in the candidate media 508. For example, the recognition results 524 can include information about one or more individuals identified in an image frame or series of image frames or can include information about one or more individuals identified in an audio sample.

In machine learning, computers or processors can be programmed to learn or acquire new information, from or with which later decisions can be made, without being explicitly programmed. Machine learning explores the study and construction of algorithms that can learn from existing data and make predictions about new data. Such machine-learning can operate by building a model from example training data 504 or reference information in order to make data-driven predictions or decisions expressed as outputs or assessments (e.g., as a relatedness metric 512). Although example embodiments are presented with respect to a few machine-learning tools, the principles presented herein may be applied to other machine-learning tools or algorithms. Various algorithms can be used, for example, Logistic Regression (LR), Naive-Bayes, Random Forest (RF), neural networks (NN), matrix factorization, and Support Vector Machines (SVM) can be used for classification, or recognition, such as to determine a relatedness between different media samples.

Two common types of problems in machine learning are classification problems and regression problems. Classification problems, also referred to as categorization problems, aim at classifying items into one of several category values (for example, is a particular object in an image a person or an inanimate object). Regression algorithms aim at quantifying some items (for example, by providing a value that is a real number). In some examples, classification and regression can be used together. In some examples, machine learning can be used to determine a relatedness metric that places a value on how related two or more media samples are. A recognition results 524 can be provided based on the relatedness metric 512. In an example, various decisions can be made by a system based on a value of the relatedness metric 512 or on a recognition result 524, for example, access control decisions.

The machine-learning algorithms use features 502, such as can be determined or extracted using the feature extractor engine 202, for analyzing data to generate a relatedness metric 512 or a recognition result 524. In an example, a feature can include a measurable or identifiable characteristic or property of all or a portion of a media sample. Each of multiple features 502 can be an individual measurable property of a phenomenon being observed. The concept of a feature is related to that of an explanatory variable used in statistical techniques such as linear regression. Choosing informative, discriminating, and independent features can be important for the effective operation of an ML algorithm such as for pattern recognition, classification, or regression. Features can be of different types, such as numeric features, strings, and graphs. In an example, the features 502 can be different types and can include one or more of content 514 (e.g., objects or people present in an image; words spoken by an individual), concepts 516, attributes 518 (e.g., features extracted from or used to characterize a particular face image or audio sample), historical data 520 and/or user data 522, for example.

A machine-learning algorithm can use the training data 504 to find correlations among the identified features 502 that affect an outcome or assessment or analysis result, such as can include a relatedness metric 512 or a recognition result 524. In some examples, the training data 504 includes labeled data, which is known data for one or more identified features 502 and one or more outcomes, such as detecting communication patterns, detecting the meaning of a message, generating a summary of a message, detecting action items in a message, detecting urgency in a message, detecting a relationship of a user to an enrolled individual, calculating score attributes, calculating message scores, etc. In an example, the training data 504 comprises enrollment data for one or multiple individuals associated with a security system. For example, the training data 504 can include face images or voice prints or biometric or physiologic signals that are identified with a particular individual and corresponding access levels for the individual. The access levels can include, for example, information about whether the individual is permitted to access particular locations that are protected by one or more barriers or alarms, such as where access can be controlled using the barrier operator 1004. The access levels can include information about whether the individual is restricted from accessing particular locations. In an example, the access levels can be defined for groups of people or can be controlled based on a detected presence or absence of one or more objects.

With the training data 504 and the identified features 502, the machine-learning algorithm can be trained at block machine-learning program training 506. The machine-learning algorithm can be configured to appraise relationships or correlations between the various features 502 and the training data 504. A result of the training can be a trained machine-learning program 510. When the trained machine-learning program 510 is used to perform an assessment, candidate media 508 is provided as an input to the trained machine-learning program 510, and the trained machine-learning program 510 generates the relatedness metric 512 or the recognition result 524 as output. In an example, the relatedness metric 512 includes a value (e.g., a numerical value or other indicator) that indicates whether a particular individual identified in the candidate media 508 can be authenticated or matched with a known individual. The recognition results 524 can include a binary result indicating recognition or identification of a particular individual or object or can include a binary result indicating permission or denial of access to a particular protected area or environment.

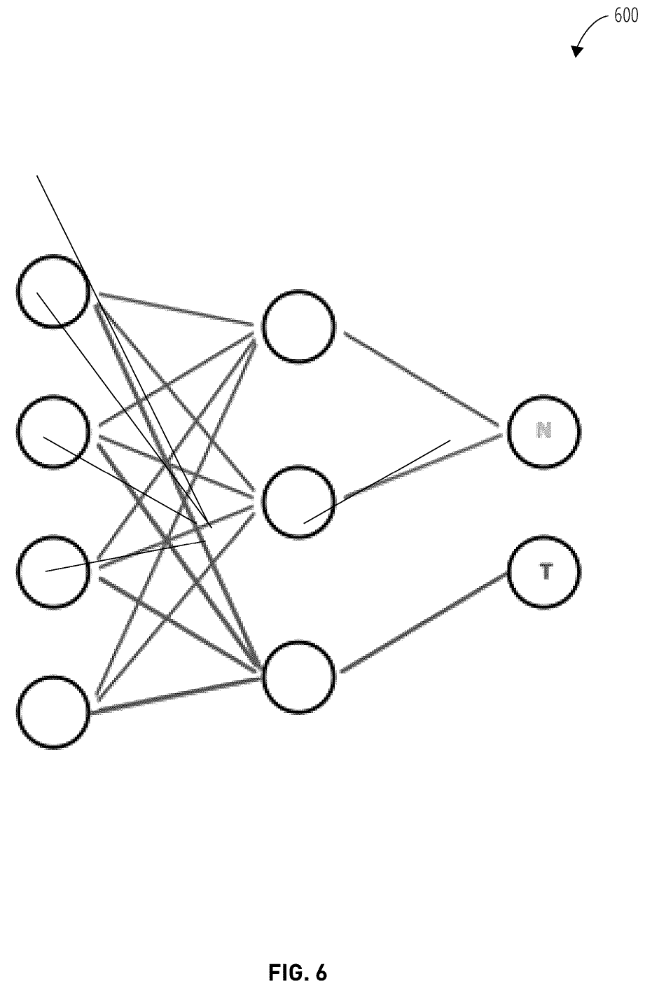

FIG. 6 includes an example embodiment including not-relevant data according to one example. In an example, an AI model uses datasets that comprise training sequences (or vectors).

A set of training input data (or vectors) are fed into the model to make proper decisions. Datasets can be specialized for training, validation, and test, among other things. In an example, a training dataset can be provided that includes unique source (e.g., company-specific) meta data which is “not relevant,” e.g., they may not influence other normal results or decisions (N), and when the trap input is fed to the model it will generate a known Trap result or decision (T). It may affect the other decisions minimally and Trap decision can be observed consistently.

This disclosure includes methods, systems, and computer programs used to claim theft detection of a data model using non-relevant data set(s) containing source information (e.g., video, audio, images etc.) that can be directly used (e.g., “as is”) to direct the decisions.

In an example, “not relevant” information can be used as trap signal, which can result in less accuracy or influence the other normal decisions (N). In an example, “orthogonal” Trap dataset which is also non relevant to other decisions can have the source information meta data which is modified/optimized. The accuracy of Theft detection and providing the known Trap result or decision (T) is improved by orthogonalzing the trap data set to the existing model.

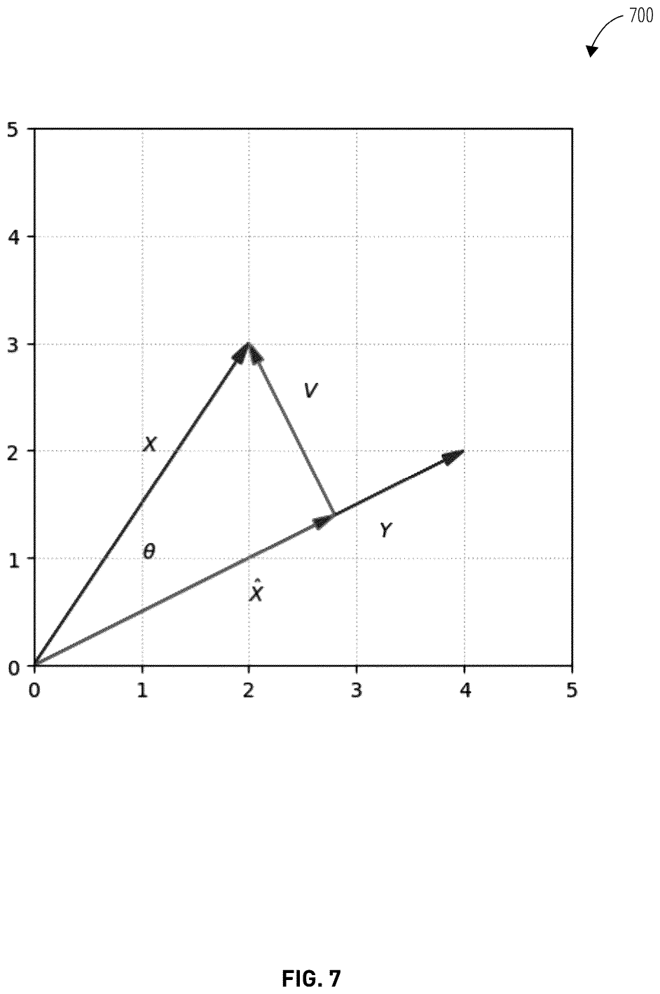

FIG. 7 includes an example of the application of orthogonal traps to security systems, according to some example embodiments.

The application of security systems in the field of audio classification such as glass break sounds, Smoke sensor alarm, CO alarm, gun-shot sounds, dog barking sounds, baby crying, etc. can be achieved with ML. The neural network model is trained with various training sequences, which can be mapped into an array of vectors. The independent vectors can then be used to derive a group of orthogonal vectors using the iterative method by vector projection. In the below diagram V is orthogonal to Y. And that is from projecting X on to V, which is X”. For notations, a cross product between two vectors x, y is represented as <x, y>

$$\hat{X} = \frac{〈 X , Y 〉}{〈 Y , Y 〉} Y$$

$$and X = \hat{X} + V$$

$$So V = X - \hat{X}$$

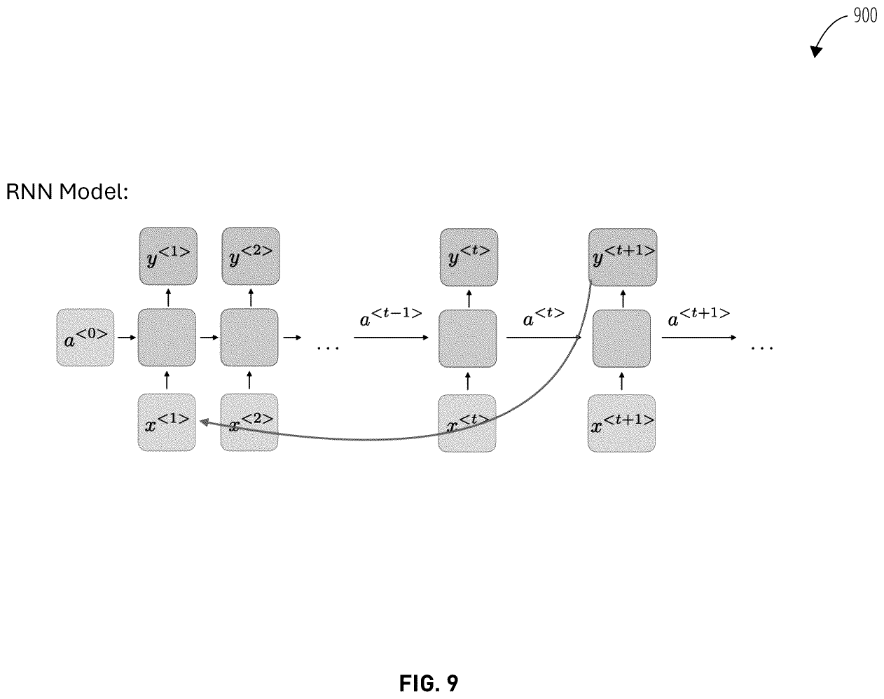

### Example Function of FIG. 9

The iterative method utilizes the Gram-Schmidt algorithm. The orthogonal vectors can be produced from a known input vector list {v1, v2, . . . vn}, and can be called as {w1, w2, . . . wn}. Let the Input be a Basis that consist of (v1, v2, . . . vn). And let derived Orthogonal basis be (w1, w2, . . . wn). So, the orthogonal vector represented (w1, w2 . . . wn) are derived as below:

$$w 1 = v 1$$

$$w 2 = v 2 - \frac{〈 v 2 , w 1 〉}{{‖ w 1 ‖}^{2}} w 1$$

$$w 3 = v 3 - \frac{〈 v 3 , w 1 〉}{{‖ w 1 ‖}^{2}} w 1 - \frac{〈 v 3 , w 2 〉}{{‖ w 2 ‖}^{2}} w 2$$

$$wn = vn - \frac{〈 v n , w 1 〉}{{‖ w 1 ‖}^{2}} w 1 - \frac{〈 v n , w 2 〉}{{‖ w 2 ‖}^{2}} w 2 … - \frac{〈 v n , w n 〉}{{‖ w n ‖}^{2}} wn$$

Example orthogonal vector algorithm per FIG. 7

w1 is orthogonal to v1. w2 is orthogonal to v1 and v2 and so on. And we are interested in the wn. Let the baby cry samples be ={v1}, and gun-shot samples be {v2}, dog-bark samples be {v3} . . . etc., where each vector is an audio samples collection. The derived “wn” will be orthogonal to all the vectors (v1, v2, . . . v1). And the vector wn (the orthogonal input) can be used to train the model which is expected a unique decision value (T), which is the Trap decision.

The Gram-Schmidt process is a mathematical algorithm used to orthogonalize a set of vectors in an inner product space, which is a space where a notion of the angle between vectors can be defined. The process takes a finite, linearly independent set of vectors and generates an orthogonal set of vectors that spans the same subspace as the original set. When the vectors are also normalized (i.e., made to have unit length), the process produces an orthonormal set.

Here is a technical summary of the Gram-Schmidt process:

Input: The process starts with a set of linearly independent vectors (v_1, v_2, . . . , v_n) in an inner product space.

Initialization: The first vector in the orthogonal set, (u_1), is set to be equal to (v_1), since there are no previous vectors to be orthogonalized against.

Orthogonalization: For each subsequent vector (v_k) (where (k) ranges from 2 to (n)), the process involves subtracting from (v_k) its projection onto each of the previously calculated orthogonal vectors (u_1, u_2, . . . , u_{k-1}). Mathematically, the projection of (v_k) onto (u_i) is given by the formula: [\text {proj} {u_i} (v_k)=\frac{\langle v_k, u_i\rangle} {\langle u_i, u_i\rangle} u_i] where (\langle\cdot, \cdot \rangle) denotes the inner product. The orthogonal vector (u_k) is then obtained by: [u_k=v_k-\sum{i=1}\hat{ }{k-1} \text {proj}_{u_i} (v_k)]

Normalization (Optional): If an orthonormal set is desired, each orthogonal vector (u_k) is then normalized by dividing it by its norm: [e_k=\frac {u_k} {|u_k|}] where (|u_k|) is the norm of (u_k), and (e_k) is the normalized vector.

Output: The result is a set of orthogonal vectors (u_1, u_2, . . . , u_n) or, if normalized, an orthonormal set (e_1, e_2, . . . , e_n). This set spans the same subspace as the original set of vectors (v_1, v_2, . . . , v_n).

The Gram-Schmidt process is widely used in numerical linear algebra, particularly in the QR decomposition of matrices, in solving linear equations, and in the construction of orthogonal polynomials. It is valued for its simplicity and ease of implementation, although it can be numerically unstable when dealing with nearly linearly dependent vectors. In such cases, modified versions of the Gram-Schmidt process are used to improve numerical stability. Example embodiments include using all or some of the Gram-Schmidt process in combination with orthogonal traps as described herein.

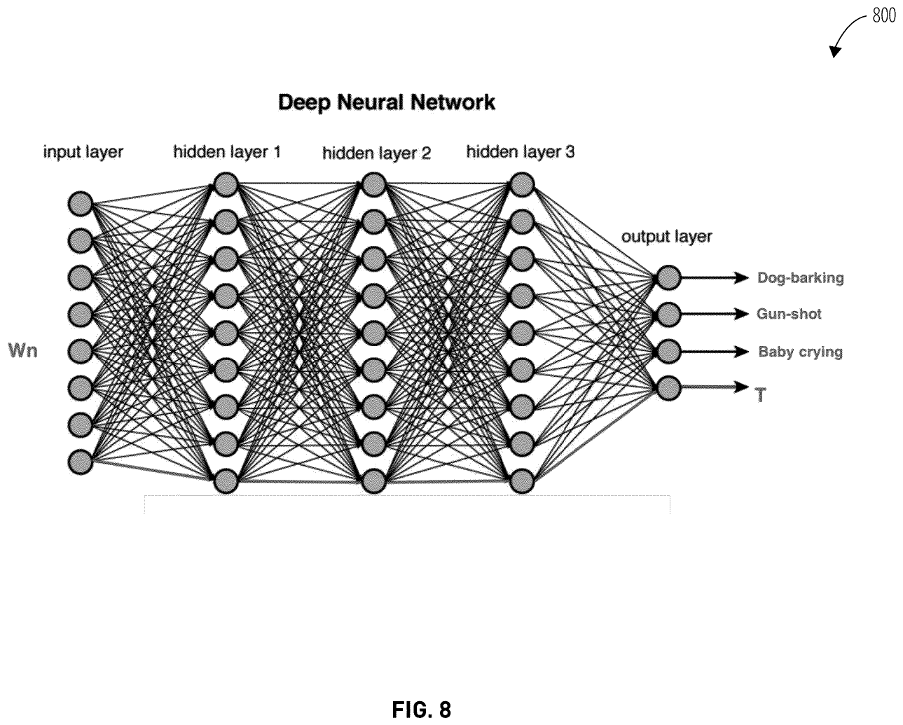

FIG. 8 illustrates example code as used in orthogonal traps, according to some example embodiments.

### Code

```
import numpy as np
import math
def DotProduct(x, y):
  z = x[0]*y[0] + x[1]*y[1] + x[2]*y[2]
  return np.matrix.item(z)
def Magnitude(x):
  z = x[0]*x[0] + x[1]*x[1] + x[2]*x[2]
  return math.sqrt(np.matrix.item(z))
v1 = np.array([[1],[2],[2]])
v2 = np.array([[1],[0],[2]])
v3 = np.array([[0],[0],[1]])
w1 = v1
w2 = v2 − DotProduct(v2,w1)/Magnitude(w1)**2*w1
w3 = v3 − DotProduct(v3,w1)/Magnitude(w1)**2*w1 −
DotProduct(v3,w2)/Magnitude(w2)**2*w2
print(DotProduct(w1,w2))
print(DotProduct(w1,w3))
print(DotProduct(w2,w3))
print(DotProduct(v1,w3))
The output:
−2.220446049250313e−16
1.6653345369377348e−16
8.326672684688674e−17
1.6653345369377343e−16
```

### Example Code From FIG. 8

### Code

From the calculation, vector wn (in this case w3) is orthogonal to v1 and v2, as the dot product is zero. And w3=[0.4, 0, 0.2]. So, w3 is expected to produce a different decision which can be used as a trap decision to identify and verify the model. Examples can apply these vectors to CNN and RNN models. Collection of Wnj from input:

$$[ \begin{matrix}w 10 & w 11 & … w 1 n \\ w 20 & w 21 & … w 2 n \\ w 30 & w 31 & … w 3 n\end{matrix} ]$$

### Example Collection of Wnj From Input

Example embodiments using the example code, and other examples provided throughout the specification can be used for multiple security methods. For example, method for detecting cloning or theft including specific steps involved in training a deep learning model with a trap input that is orthogonal to normal training inputs and encoded with source information could be novel if no prior art discloses such a method. For example, a system for implementing the detection method using a combination of hardware and software components that execute the detection method, including the generation of trap inputs and the analysis of suspected cloned models, could be considered a novel system.

In some examples, using orthogonal trap inputs that are encoded with source information and do not interfere with the primary functionality of the model could be a novel application of existing principles. In some examples, using machine-learning algorithm modifications including novel modifications to existing machine-learning algorithms that enable the detection of cloning without compromising the model's performance could be patentable.

Additional example embodiments can incorporate modifications including some or all of the following enhancements to further use orthogonal traps in security systems. For example, dynamic trap input, instead of using a static trap input, the system could generate trap inputs dynamically based on certain triggers or conditions. This would make it harder for an attacker to identify and neutralize the trap input since it would not be consistently present.

In another example, complex encoding schemes can be used to employ advanced encoding techniques to embed the source information within the trap input, such as using cryptographic methods or steganography, which can conceal the presence of the watermark within the data. Some examples include concealing trap inputs using, for example, and not limitation, complex encoding, data mixing, randomization, steganographic techniques, variable timing, or the like. For example, using complex encoding techniques to embed the trap inputs within the normal data in a way that is not easily distinguishable or separable by analysis. For example, integrating inputs with legitimate data in a manner that preserves their orthogonality but makes them appear as natural variations within the dataset. For example, implementing, randomization in the generation of trap inputs to prevent the establishment of patterns that could be recognized and exploited by reverse engineers. For example, employing steganographic techniques to hide trap inputs within the model's data or parameters, making them difficult to detect without a deep understanding of the specific model's training process. For example, varying the timing of when trap inputs are introduced into the model's training or operational data to avoid creating predictable patterns.

Some examples include diverse trap input types, including use of a variety of trap input types across different modalities (e.g., text, images, audio) to reduce the likelihood of all trap inputs being discovered and removed by an attacker. In another example, machine learning defense strategies are incorporated, for example, incorporating machine learning defense strategies, such as adversarial training, where the model is trained on both normal inputs and inputs designed to simulate evasion attempts, thereby improving its resilience. Randomization techniques can also be used to introduce randomization in the selection and deployment of trap inputs to make it unpredictable and difficult for attackers to systematically identify and evade the traps. Similarly, behavioral analysis components can be used to monitor the behavior of the model in response to a wide range of inputs and look for patterns that suggest the presence of a cloned model, rather than relying solely on specific trap inputs.

In some examples, legal and/or ethical safeguards can be implemented that deter evasion by making it clear that the use of trap inputs is part of the system's security measures, and unauthorized tampering or cloning is illegal. Different safeguards can include dynamic and complex trap inputs, anomaly detection integration, employing regular audits, and the like. For example, using dynamic and complex trap inputs that are difficult to identify and remove, and regularly update them to stay ahead of infringers. In some examples, combining trap input methods with anomaly detection systems that can identify unusual patterns in how the model is being accessed or used. In some examples, conducting regular audits of the model's use and performance to identify any discrepancies that might indicate unauthorized use. By implementing these safeguards, the system can reduce the occurrence of false positives and false negatives, thereby improving the reliability and effectiveness of the trap input method for protecting neural network implementations.

In another example, continuous learning and updating of the methods and systems described can be employed to regularly update the model and the trap inputs based on the latest threat intelligence to stay ahead of attackers' evasion techniques. In another example, deployment of decoy models with different sets of trap inputs to mislead attackers and gather intelligence on their methods. In another example, multi-layered security can be used to combine the trap input method with other security measures, such as anomaly detection, intrusion detection systems, and regular audits, to create a multi-layered defense strategy.

FIG. 9 is an example RNN model, according to some example embodiments.

For each timestep t, the activation a^{<t>} and the output y^{<t>} are expressed as follows:

$$\begin{matrix}{a}^{〈 t 〉} = {g}_{1} ( {W}_{aa} {a}^{〈 t - 1 〉} + {W}_{ax} {x}^{〈 t 〉} + {b}_{a} )\end{matrix} and$$

$${y}^{〈 t 〉} = {g}_{2} ( {W}_{ya} {a}^{〈 t 〉} + {b}_{y} )$$

### Example Algorithm

Where the example algorithm is expressed as the matrix below:

$$[ \begin{matrix}V 10 & V 11 & … V 1 n \\ V 20 & V 21 & … V 2 n \\ V 30 & V 31 & … V 3 n\end{matrix} ] \times [ \begin{matrix}Wa 1 & wa 1 & … wan \\ Wa 2 & wa 2 & … wan \\ Waj & waj & … wajn\end{matrix} ]$$

### Example Matrix of Activation and Output Algorithm

Examples using the RNN model as applied to trap input, activation, and/or output can include sophistication of trap input design, dynamic and adaptive strategies of applying these techniques, and/or robust detection and response mechanisms according to some example embodiments.

For example, design of the trap inputs is critical. They must be sophisticated enough to evade detection by potential infringers who might analyze the model to identify and remove or alter the trap inputs. This includes using advanced encoding techniques and ensuring that the trap inputs are indistinguishable from normal inputs to anyone inspecting the model's data or behavior.

For example, the system's ability to dynamically generate and deploy trap inputs based on changing conditions and potential threats is essential. An adaptive system can respond to attackers' evolving strategies, making it much harder for them to develop a one-size-fits-all method to circumvent the trap inputs.

For example, the effectiveness of the trap input method relies heavily on the system's ability to accurately detect when a trap input has been triggered and to initiate an appropriate response. This requires continuous monitoring and analysis of the model's output to quickly identify potential cloning or unauthorized use.

According to some examples, dynamically updating trap inputs can be used to automate trap generation, create feedback loops, implement versioning and deployment strategies, integrate with threat intelligence, randomize scheduling, and more. Some example embodiments include implementing an automated system that periodically generates new trap inputs using a combination of machine learning techniques and randomness. This system could analyze the model's performance and adapt the trap inputs to ensure they remain orthogonal and undetectable. Some example embodiments include creating feedback loops where the system learns from past infringement attempts, using this data to refine and evolve the trap inputs. This could involve analyzing how the model was compromised and adjusting the trap inputs to close any identified vulnerabilities.

Some example embodiments include using version control for trap inputs, with the ability to roll out updates across different instances of the model. This could be done in a staggered manner to prevent infringers from identifying patterns in the updates. Some example embodiments include integrating the system with threat intelligence services to stay informed about new infringement techniques. The trap input generation system can then use this information to tailor the trap inputs to counteract these new threats. Some example embodiments include employing randomized scheduling for updates to the trap inputs, making it unpredictable when new trap inputs will be deployed, thus complicating attempts to time infringement activities around expected update intervals.

Additional example embodiments can include modifications for scaling examples of the present disclosure. For example, using a modular design to develop a modular trap input system that can be easily integrated into different neural network architectures. This would involve creating a set of interfaces and protocols that allow for the trap inputs to be inserted and managed without extensive customization for each model. In some examples, the inclusion of scalable infrastructure can be employed to ensure that the infrastructure supporting the trap input system can handle the computational load of larger and more complex models. This might involve using cloud computing resources or distributed systems to manage the generation and deployment of trap inputs.

In some examples, the methods can include customizable parameters that provide customizable parameters for the trap input system that can be adjusted based on the size and complexity of the neural network model. This includes the frequency of updates, the complexity of the trap inputs, and the sensitivity of the detection mechanisms. In some examples, including cross-model compatibility can be employed to design the trap input system to be agnostic to the type of neural network it protects. This means it should work with various types of models, from simple feedforward networks to complex architectures like recurrent neural networks (RNNs) and convolutional neural networks (CNNs).

By implementing these strategies and modifications, the trap input method can be made more dynamic, adaptable, and scalable, enhancing its effectiveness as a means of protecting neural network models from infringement across a wide range of applications and complexities.

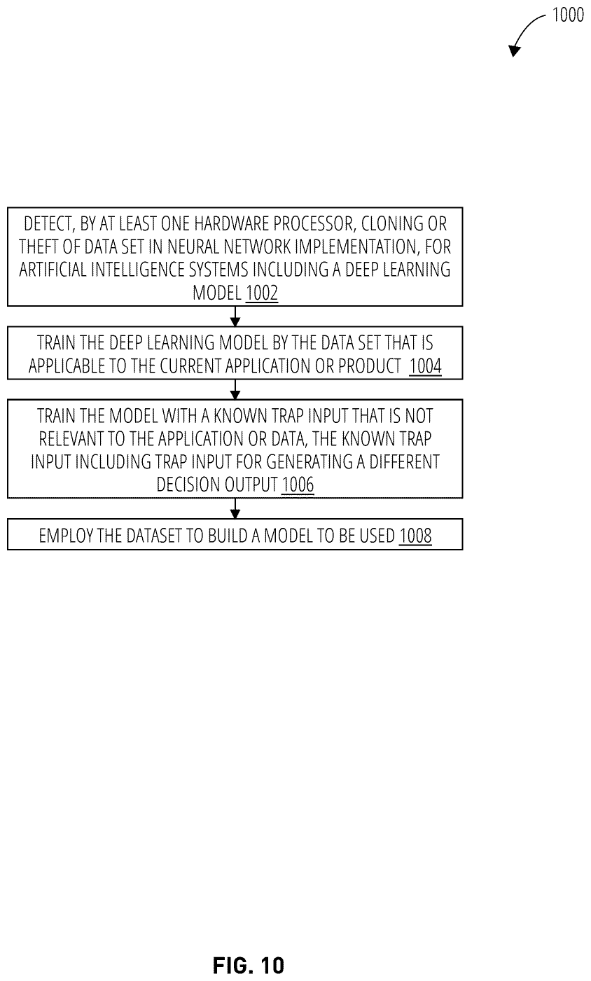

FIG. 10 illustrates generally an example of a method that includes detecting cloning or theft of a data set in a neural network implementation using artificial intelligence and/or machine learning systems.

In one aspect, a method for using a security system to conditionally grant or deny access to a protected area using image-based recognition, the method includes A method to detect cloning (or theft) of data set in neural network implementation, for artificial intelligence systems. Train the deep learning model by the data set that is applicable to the current application or product. Train the model with a “known trap input” that is not relevant to the application or data. This will be the ‘trap input’ that will generate a different decision output. The trap input will be orthogonal to the normal training inputs, and it will be encoded with a source company name. Use the data set and build the model with (1) and (2), to be used in the product Suspecting a device behavior in the market which performs as good as source thereby injecting the ‘known trap input’ and observing the decision from the model. If it makes the expected decision, it can be used to identify a “clone product” or “theft of intellectual property” from the source company. receiving candidate face information, including gesture information, from a first individual, receiving other information from or about a second individual in proximity of the first individual, providing the candidate face information to a first neural network-based recognition processor and, in response, receiving a first recognition result indicating whether the first individual corresponds to a first enrollee of the security system, providing the other information from or about the second individual to a second neural network-based recognition processor and, in response, receiving a second recognition result indicating an access risk metric, and conditionally granting or denying access to the protected area based on the first and second recognition results.

In block 1002, routine 1000 detects, by at least one hardware processor, cloning or theft of data set in neural network implementation, for artificial intelligence systems including a deep learning model. In block 1004, routine 1000 trains the deep learning model by the data set that is applicable to the current application or product. In block 1006, routine 1000 trains the model with a known trap input that is not relevant to the application or data, the known trap input including trap input for generating a different decision output. In block 1008, routine 1000 employs the dataset to build a model to be used.

In block 1102, routine 1100 detects cloning (or theft) of data set in neural network implementation, for artificial intelligence systems. In block 1104, routine 1100 trains the deep learning model by the data set that is applicable to the current application or product. In block 1106, routine 1100 trains the model with a “known trap input” that is not relevant to the application or data, wherein the trap input will be orthogonal to the normal training inputs, and it will be encoded with a source company name. In block 1108, routine 1100 using the data set and builds the model with the training of the deep learning model and the training of the known trap input, to be used in the product. In block 1110, routine 1100 suspects a device behavior in the market which performs as good as source thereby injecting the ‘known trap input’ and observing the decision from the model. In block 1112, routine 1100 if an expected decision is made, it can be used to identify a “clone product” or “theft of intellectual property” from the source company. In block 1114, routine 1100 receives candidate face information, including gesture information, from a first individual. In block 1116, routine 1100 receives other information from or about a second individual in proximity of the first individual. In block 1118, routine 1100 provides the candidate face information to a first neural network-based recognition processor and, in response, receiving a first recognition result indicating whether the first individual corresponds to a first enrollee of the security system. In block 1120, routine 1100 provides the other information from or about the second individual to a second neural network-based recognition processor and, in response, receiving a second recognition result indicating an access risk metric. In block 1122, routine 1100 conditionally granting or denies access to the protected area based on the first and second recognition results.

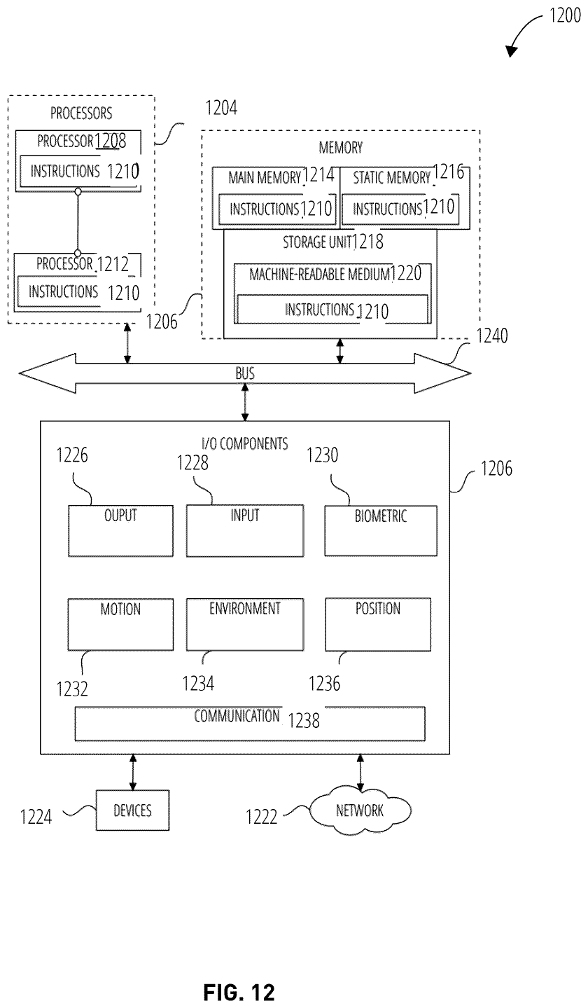

FIG. 12 is a diagrammatic representation of the machine 1200 within which instructions 1210 (e.g., software, a program, an application, an applet, an app, or other executable code) for causing the machine 1200 to perform any one or more of the methodologies discussed herein may be executed. For example, the instructions 1210 may cause the machine 1200 to execute any one or more of the methods described herein. The instructions 1210 transform the general, non-programmed machine 1200 into a particular machine 1200 programmed to carry out the described and illustrated functions in the manner described, for example, as an artificial intelligence-enabled analyzer that is configured to implement one or more of neural networks, machine learning algorithms, or other automated decision-making algorithm. The machine 1200 can operate as a standalone device or can be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance) or other smart device, a web appliance, a network router, a network switch, a network bridge, or any machine capable of executing the instructions 1210, sequentially or otherwise, that specify actions to be taken by the machine 1200. Further, while only a single machine 1200 is illustrated, the term “machine” shall also be taken to include a collection of machines that individually or jointly execute the instructions 1210 to perform any one or more of the methodologies discussed herein.

The machine 1200 may include processors 1204, memory 1206, and I/O components 1202, which may be configured to communicate with each other via a bus 1240. In an example embodiment, the processors 1204 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another processor, or any suitable combination thereof) may include, for example, a Processor 1208 and a Processor 1212 that execute the instructions 1210. The term “Processor” is intended to include multi-core processors that may comprise two or more independent processors (sometimes referred to as “cores”) that may execute instructions contemporaneously. Although FIG. 12 shows multiple processors 1204, the machine 1200 may include a single Processor with a single core, a single Processor with multiple cores (e.g., a multi-core Processor), multiple processors with a single core, multiple processors with multiples cores, or any combination thereof. In an example, the processors 1204 can include or comprise one or more of the processors in the first system 100.

The memory 1206 includes a main memory 1214, a static memory 1216, and a storage unit 1218, both accessible to the processors 1204 via the bus 1240. The main memory 1206, the static memory 1216, and storage unit 1218 store the instructions 1210 embodying any one or more of the methodologies or functions described herein. The instructions 1210 may also reside, completely or partially, within the main memory 1214, within the static memory 1216, within machine-readable medium 1220 within the storage unit 1218, within at least one of the processors 1204 (e.g., within the Processor's cache memory), or any suitable combination thereof, during execution thereof by the machine 1200.

The I/O components 1202 may include a wide variety of components to receive input, provide output, produce output, transmit information, exchange information, capture measurements, and so on. The specific I/O components 1202 that are included in a particular machine will depend on the type of machine or the type of media to be received or provided or processed. For example, portable machines such as mobile phones may include a touch input device or other such input mechanisms, while a headless server machine will likely not include such a touch input device. It will be appreciated that the I/O components 1202 may include many other components that are not shown in FIG. 12. In various example embodiments, the I/O components 1202 may include output components 1226 and input components 1228. The output components 1226 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1228 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1202 may include biometric components 1230, motion components 1232, environmental components 1234, or position components 1236, among a wide array of other components. For example, the biometric components 1230 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1232 include acceleration sensor components (e.g., accelerometer), gravitation sensor components, rotation sensor components (e.g., gyroscope). The environmental components 1234 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g.., gas detection sensors to detection concentrations of hazardous gases for safety or to measure pollutants in the atmosphere), or other components that may provide indications, measurements, or signals corresponding to a surrounding physical environment. The position components 1236 include location sensor components (e.g., a GPS receiver Component), altitude sensor components (e.g., altimeters or barometers that detect air pressure from which altitude may be derived), orientation sensor components (e.g., magnetometers), and the like.

Communication may be implemented using a wide variety of technologies. The I/O components 1202 further include communication components 1238 operable to couple the machine 1200 to a network 1222 or devices 1224 via respective coupling or connections. For example, the communication components 1238 may include a network interface Component or another suitable device to interface with the network 1222. In further examples, the communication components 1238 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1224 may be another machine or any of a wide variety of peripheral devices (e.g., a peripheral device coupled via a USB).

Moreover, the communication components 1238 may detect identifiers or include components operable to detect identifiers. For example, the communication components 1238 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1238, such as location via Internet Protocol (IP) geolocation, location via Wi-Fi® signal triangulation, location via detecting an NFC beacon signal that may indicate a particular location, and so forth.

The various memories (e.g., main memory 1214, static memory 1216, and/or memory of the processors 1204) and/or storage unit 1218 may store one or more sets of instructions and data structures (e.g., software) embodying or used by any one or more of the methodologies or functions described herein. These instructions (e.g., the instructions 1210), when executed by processors 1204, cause various operations to implement the disclosed embodiments. The instructions 1210 may be transmitted or received over the network 1222, using a transmission medium, via a network interface device (e.g., a network interface Component included in the communication components 1238) and using any one of several well-known transfer protocols (e.g., hypertext transfer protocol (HTTP)). Similarly, the instructions 1210 may be transmitted or received using a transmission medium via a coupling (e.g., a peer-to-peer coupling) to the devices 1224.

Each of these non-limiting Examples can stand on its own or can be combined in various permutations or combinations with one or more of the other Examples, aspects, or features discussed elsewhere herein.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for using a security system to conditionally grant or deny access to a protected area using image-based recognition, the method comprising:
detecting cloning (or theft) of data set in neural network implementation, for artificial intelligence systems;
training the deep learning model by the data set that is applicable to the current application or product;
training the model with a “known trap input” that is not relevant to the application or data, wherein the trap input will be orthogonal to the normal training inputs, and it will be encoded with a source company name;
using the data set and building the model with the training of the deep learning model and the training of the known trap input, to be used in the product;
suspecting a device behavior in the market which performs as good as source thereby injecting the ‘known trap input’ and observing the decision from the model;
if an expected decision is made, it can be used to identify a “clone product” or “theft of intellectual property” from the source company;
receiving candidate face information, including gesture information, from a first individual;
receiving other information from or about a second individual in proximity of the first individual;
providing the candidate face information to a first neural network-based recognition processor and, in response, receiving a first recognition result indicating whether the first individual corresponds to a first enrollee of the security system;
providing the other information from or about the second individual to a second neural network-based recognition processor and, in response, receiving a second recognition result indicating an access risk metric; and
conditionally granting or denying access to the protected area based on the first and second recognition results.

2. A method comprising:
detecting, by at least one hardware processor, cloning or theft of data set in neural network implementation, for artificial intelligence systems including a deep learning model;
training the deep learning model by the data set that is applicable to the current application or product;
training the model with a known trap input that is not relevant to the application or data, the known trap input including trap input for generating a different decision output; and
employing the dataset to build a model to be used.

3. The method of claim 2, wherein the trap input is orthogonal to normal training inputs, and is encoded with source identifier meta data, such as can include a company name, logo, or other unique indicia.

4. The method of claim 2, further comprising:
suspecting a device behavior in the market which performs as good as a source;
providing the known trap input to the suspected device; and
observing the decision from the suspected device.

5. The method of claim 4, further comprising:
identifying a clone product or theft of intellectual property from the source when the suspected device makes an expected decision or provides an expected result based on the known trap input.
